(19) United States
(12) Patent Application Publication
(10) Pub. No.: US 2021/0146454 A1
(43) Pub. Date: May 20, 2021

(54) HOLE SAW

(71) Applicant: Jan Anders FORSELL, Onsala (SE)

(72) Inventor: Jan Anders FORSELL, Onsala (SE)

(21) Appl. No.: 16/637,434

(22) PCT Filed: Aug. 7, 2018
(86) PCT No.: PCT/SE2018/050798

§ 371 Date: Feb. 7, 2020

(30) Foreign Application Priority Data
Aug. 9, 2017 (SE) 1750980-3

(51) Int. Cl. B23B 51/04

(52) U.S. Cl. CPC B23B 51/0406

(57) ABSTRACT

A hole saw comprising a cylindrical unit with an expanse in a longitudinal direction, the cylindrical unit being rotation-symmetrical about a center axis, which has an expanse in the longitudinal direction. The cylindrical unit is attached to a mounting device at one end and has a processing edge at the opposite end. The cylindrical unit is made of a homogeneous material provided to process the material to be holed by means of grinding via the processing edge.

### TECHNICAL FIELD

The description relates to a hole saw comprising a cylindrical unit with an expanse in a longitudinal direction. The cylindrical unit is rotation-symmetrical about a center axis, which has an expanse in the longitudinal direction. The cylindrical unit is attached in a mounting device at the one end and has a processing edge at the opposite end.

### BACKGROUND

Hole saws with different cutting edges have been known for a long time. The edges typically consist of saw teeth in different materials, and common for all hole saws known today is that when the edges are used up, the hole saw will have to be replaced. For e.g. plumbing/HWS (heating, water and sanitation), it is common to make holes in metal pipes to couple further pipes onto them. Hole saws for metallic material have particularly provided cutting edges, which must be able to process the metal and withstand the heat generation. It is known to use various types of special steel and diamond-fitted edges, which are expensive and complicated to produce. A hole saw known today lasts as long as the edges last, which as regards metallic materials is usually about 1-10 times, depending on the quality of the edges and the material to be processed. It should also be noted that when the cutting edges engage with the material to be processed, it is not unusual that the edges get stuck in the material, whereby the apparatus in which the hole saw is arranged begins to spin unintentionally, making it uncomfortable for the user. This is especially a serious problem for an inexperienced user.

There is thus a desire to achieve an improved hole saw, wherein the disadvantages mentioned above are reduced and in the best case are completely avoided.

### SUMMARY

The description relates to a hole saw that eliminates the problems mentioned above. As in the prior art technique, the hole saw comprises a cylindrical unit with an expanse in a longitudinal direction. The cylindrical unit is rotation-symmetrical about a center axis, which has an expanse in the longitudinal direction. The cylindrical unit is attached in a mounting device at the one end and has a processing edge at the opposite end.

The disadvantages mentioned above are reduced, and in certain cases completely eliminated, by the cylindrical unit being made of a homogeneous material provided for processing the material to be holed by means of grinding via the processing edge. The cylindrical unit is provided in one layer and the processing edge interconnects an interior and an exterior of the cylindrical unit. Given that the cylindrical unit grinds the material to be processed instead of processing it by cutting, the problem of the edges getting stuck in the material is eliminated. The distance between the processing edge and the mounting device is reduced given that the material in the cylindrical unit is worn down during processing, but here the processing edge has the same characteristics independently of the distance between the processing edge and the mounting device as long as a cylindrical part of the cylindrical unit remains. The advantage here is that as the cylindrical unit is made of a homogeneous material, the processing edge will never become blunt, but will retain its original processing capability until the cylindrical unit is so worn down that it is no longer possible to make holes. This grinding unit increases the life of the hole saw, and moreover it is inexpensive to produce. The processing edge is thus constituted by the side between the interior and the exterior of the cylindrical unit.

According to one example, the hole saw comprises a guide drill provided in the rotation center of the cylindrical unit, whereby the guide drill has a length in longitudinal direction, which exceeds the length of the cylindrical unit. The guide drill is intended to guide the hole saw when processing by making a first central hole, in which the guide drill subsequently travels.

According to one example, the mounting device comprises an attachment device for the guide drill. According to one example, the attachment device is provided to permanently attach the guide drill. The guide drill can be attached by way of any known type of joining, e.g. joining by pressing or clipping, soldering, welding or by manufacturing the guide drill integrally with the attachment device. According to another example, the attachment device is provided to removably attach the guide drill. The guide drill may e.g. be attached by way of a nut or the like, which is provided to apply a lateral force on the guide drill when it is in attachment with the attachment device. Other variants comprise attaching the guide drill via a so-called bayonet attachment, where the guide drill has a specifically provided end portion, which is arranged to be inserted longitudinally in the attachment, after which the guide drill is twisted so that the abutment surface of the end portion is abutting the corresponding abutment surface of the attachment so that they engage and lock the guide drill. Such a device may be equipped with a spring device that pushes back the guide drill towards the attachment to keep the guide drill in a locked position in this way. An advantage of a removable guide drill is that it can be replaced if it breaks before the hole drill is used up.

According to one example, the mounting device comprises a reinforcement part that connects the cylindrical unit with the attachment device. The reinforcement part can absorb the load from the attachment device and distribute it across a larger area on the other parts of the cylindrical unit, which may consist of another material than the reinforcement part.

According to one example, the cylindrical unit comprises folded sides and an end portion in connection with the mounting device. The folded sides may constitute the end portion. If the mounting device comprises the reinforcement part, the reinforcement part is attached to the end portion. In the case that the reinforcement part is missing, the folded end portion can be attached directly to an attachment area of the mounting device.

According to one example, the cylindrical unit comprises an abrasive and a binder to bind the abrasive. An advantage of using such material is that the cylindrical unit may be constructed in any form and length in a material adapted to the material to be processed. Such optional form could e.g. be the cylindrical unit with folded sides mentioned above. According to one example, the cylindrical unit comprises arming. Such arming is equally distributed in the cylindrical unit, so that the processing edge has the same characteristics regardless of how much the cylindrical unit has been worn down.

It could be mentioned that the material in the cylindrical unit advantageously is made of similar material as in an abrasive cutoff wheel, which also consists of abrasive and binder. The material can be made with various sizes of the particles of the abrasive. The size of the particles and the choice of material of the particles can be optimized relative to the material intended to be processed, e.g. wood, plaster, metal, plastic and rubber.

The mounting device comprises a fixing plug provided to be able to connect the hole saw to an apparatus. The apparatus is provided to rotate the hole saw at a very high speed. Adequate speed is in the size of 11,500 revolutions per minute, which corresponds to the rotation speed of a disc sander known today. It should be noted that a disc sander is an advantageous apparatus to use as it is established on the market and has standardized mounting devices, which fit into corresponding mounting devices suggested for the described hole saw.

According to one example, the mounting device comprises a receiving unit, in which the cylindrical unit is attached. The receiving unit may consist of one or more parts, in which the cylindrical unit is attached. The receiving unit may alternatively consist of a cylindrical part, in which the cylindrical unit is attached. According to one example, the receiving unit comprises a part with an expanse in radial direction. Here radial direction means a direction perpendicular to the longitudinal direction. According to one example, the receiving unit comprises a flat area in a single plane with a normal line in the longitudinal direction, where the cylindrical unit is in place. The cylindrical unit can here be attached to the flat area. According to one example, the receiving unit comprises a part with an expanse in the radial direction and with flanges in a direction that coincides the longitudinal direction. The cylindrical unit can here be attached to the receiving unit via the flanges. According to one example, the flanges are one-sided, i.e. provided to be attached to the exterior or the interior of the cylindrical unit. According to one example, the flanges are double-sided, i.e. provided to be attached to the exterior and the interior of the cylindrical unit.

According to one example, the mounting device comprises guides in the flanges with an expanse in longitudinal direction, provided to receive guide pins provided on the cylindrical unit in radial direction. Alternatively, the mounting device can comprise guide pins in radial direction and the cylindrical unit corresponding guides in longitudinal direction. The guides lock the guide pins and thereby the cylindrical unit until the mounting device secures rotation of the cylindrical unit together with the mounting device. The mounting device can also comprise adapters that enable simple mounting of various sizes of the cylindrical unit. Here an adapter can comprise guides with an expanse in longitudinal direction, provided to receive guide pins provided on the cylindrical unit in radial direction. Alternatively, the adapter can comprise guide pins in radial direction and the cylindrical unit corresponding guides in longitudinal direction. Adapters with both guide pins in radial direction and corresponding guides in longitudinal direction may also occur.

According to one example, the mounting device comprises a stabilization device, which secures the cylindrical unit in place in the mounting device. The stabilization device can be constituted by one or more rings in a flexible material, which are placed between the cylindrical unit and the flanges. The rings can be placed around the cylindrical unit before it is placed in the mounting device and/or can be placed inside the mounting device along the flanges.

The guide drill can be replaced by a guide device if there is already a guide hole pre-drilled in the material.

### BRIEF DESCRIPTION OF FIGURES

The device is described below in connection with a number of figures, wherein:

FIG. 1 schematically shows a side view of a hole saw according to an example before use;

FIG. 2 schematically shows a side view of a hole saw according to FIG. 1 after use for a while;

FIG. 3 schematically shows a top view of a hole saw according to FIG. 1 or 2;

FIG. 4 schematically shows a side view of a hole saw according to an example before use;

FIG. 5 schematically shows a top view of a cylindrical unit of a hole saw according to FIG. 4;

FIG. 6 schematically shows a top view of the mounting device for a hole saw according to FIG. 4 and a cylindrical unit according to FIG. 5;

FIG. 7 schematically shows a top view of an example of an adapter for a cylindrical unit according to FIG. 5;

FIG. 8 schematically shows a top view of an example of an adapter for a cylindrical unit according to FIG. 5;

### DESCRIPTION OF EXEMPLARY EMBODIMENT

Various aspects of the device will now be described in connection with the accompanying drawings to illustrate but not limit the device. In the description the same reference symbols will be used for the same characteristics in the various figures. It should also be mentioned that the device is not limited to the embodiments shown, but additional variations are possible within the scope of protection as set forth in the appended claims.

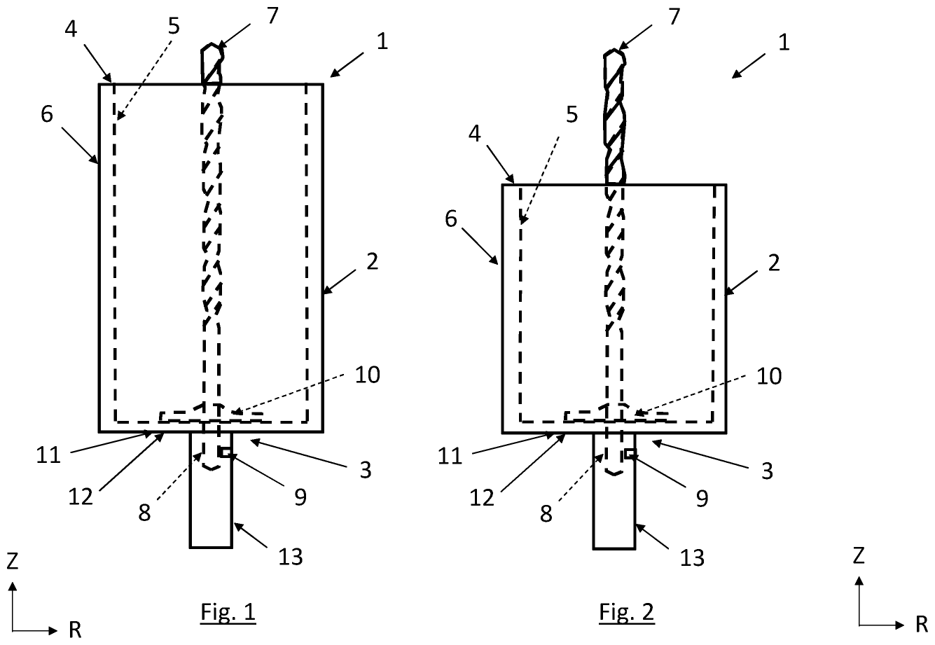

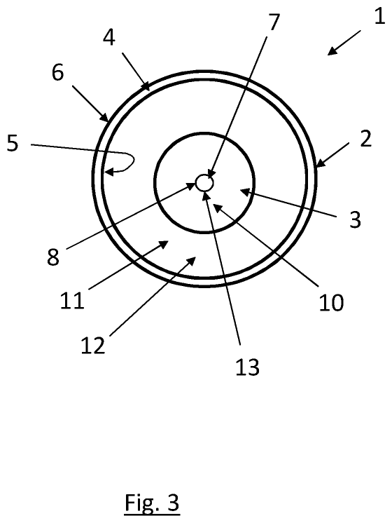

FIG. 1 schematically shows a side view of a hole saw 1 before use. FIG. 2 schematically shows a side view of a hole saw 1 after use for a while. FIG. 3 schematically shows a top view of a hole saw 1 according to FIG. 1 or 2. FIGS. 1 and 2 show a hole saw 1, comprising a cylindrical unit 2 with an expanse in a longitudinal direction Z. The cylindrical unit 2 is rotation-symmetrical about a center axis, which has an expanse in the longitudinal direction Z. The cylindrical unit 2 is attached in a mounting device 3 at the one end and has a processing edge 4 at the opposite end.

The cylindrical unit 2 is made of a homogeneous material provided to process the material to be holed by means of grinding via the processing edge 4. The cylindrical unit 2 is provided in one layer and the processing edge 4 interconnects an interior 5 and an exterior 6 of the cylindrical unit 2. Given that the cylindrical unit 2 grinds the material to be processed instead of processing it by cutting, the problem of the edges getting stuck in the material is eliminated. Compared with FIG. 1, FIG. 2 shows that the distance between the processing edge 4 and the mounting device 3 is reduced given that the material in the cylindrical unit 2 is worn down during the processing, but the processing edge 4 has the same characteristics independently of the distance between the processing edge 4 and the mounting device 3 as long as a cylindrical part of the cylindrical unit 2 remains. The advantage here is that as the cylindrical unit 2 is made of a homogeneous material, the processing edge 4 will never become blunt, but will retain its original processing capability until the cylindrical unit 2 is so worn down that it is no longer possible to make holes. This grinding unit increases the life of the hole saw, and moreover it is inexpensive to produce. The processing edge 2 is thus constituted by the side between the interior 5 and the exterior 6 of the cylindrical unit 2.

FIGS. 1-3 show that the hole saw 1 comprises a guide drill 7 provided in the rotation center of the cylindrical unit 2, whereby the guide drill 7 has a length in longitudinal direction Z, which exceeds the length of the cylindrical unit 2. The guide drill 7 is intended to guide the hole saw 1 during processing by making a first central hole, in which the guide drill 7 subsequently travels.

FIGS. 1 and 2 show that the mounting device 3 comprises an attachment device 8 for the guide drill 7. According to one example (not shown), the attachment device 8 is provided to permanently attach the guide drill 7. The guide drill 7 can be attached by way of any known type of joining, e.g. joining by pressing or clipping, soldering, welding or by manufacturing the guide drill integrally with the attachment device. According to FIGS. 1 and 2, the attachment device 8 is provided to removably attach the guide drill 7. In FIGS. 1 and 2, the guide drill 7 is attached by way of a nut 9 or the like, which is provided to apply a lateral force on the guide drill 7 when it is attached to the attachment device 8. Other variants (not shown) are that the guide drill 7 is attached via a so-called bayonet attachment, wherein the guide drill has a specifically provided end portion, which is arranged to be inserted longitudinally in the attachment, after which the guide drill is twisted so that the abutment surface of the end portion is abutting the corresponding abutment surface of the attachment so that they engage and lock the guide drill. Such a device may be equipped with a spring device that pushes back the guide drill towards the attachment to keep the guide drill in a locked position in this way. An advantage of a removable guide drill is that it can be replaced if it breaks before the hole drill is used up.

According to FIGS. 1-3, the mounting device 3 comprises a reinforcement part 10 that connects the cylindrical unit 2 with the attachment device 8. The reinforcement part 10 can absorb the load from the attachment device 8 and distribute it across a larger area on the other parts of the cylindrical unit 2, which may consist of another material than the reinforcement part 10.

According to FIGS. 1-2, the cylindrical unit 2 comprises folded sides 11 and an end portion 12 in connection with the mounting device 3. The folded sides 11 may constitute the end portion 12. If the mounting device 3 comprises the reinforcement part 10, the reinforcement part 10 is attached to the end portion 12. In the case that the reinforcement part 10 is missing, the folded end portion 12 can be attached directly to an attachment area of the mounting device 3.

FIGS. 1-3 show that the mounting device 3 comprises a fixing plug 13 provided to be able to connect the hole saw 1 to an apparatus (not shown). The apparatus is provided to rotate the hole saw 1 at very high speed to be able to use the grinding capacity of the material optimally.

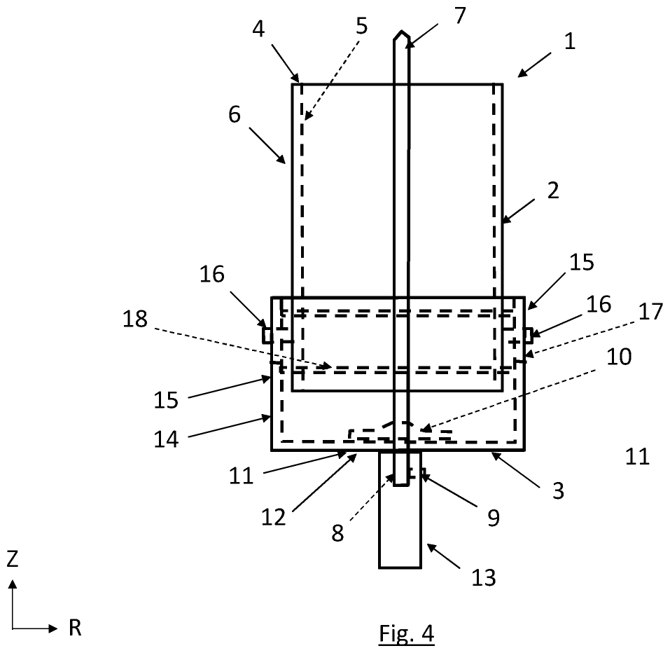

FIG. 4 schematically shows a side view of a hole saw 1 according to an example before use. FIG. 4 shows an example, where the mounting device 3 comprises a receiving unit 14, to which the cylindrical unit 2 is attached. The receiving unit 14 may consist of one or more parts, to which the cylindrical unit 2 is attached. According to one example, the receiving unit 14 comprises a part 12 with an expanse in radial direction R. By radial direction is intended a direction perpendicular to the longitudinal direction Z. According to one example, the receiving unit 14 comprises a flat area 12 in a single plane with a normal line in the longitudinal direction Z, where the cylindrical unit 2 is in place. The cylindrical unit 2 can here be attached to the flat area 12. FIG. 4 shows an example, where the receiving unit 14 comprises a part 12 with an expanse in the radial direction R and with flanges 15 in a direction that coincides with the longitudinal direction. The cylindrical unit 2 can here be attached to the receiving unit via the flanges 15. According to the example in FIG. 4, the flanges 15 are one-sided, i.e. provided to be attached to the exterior or the interior of the cylindrical unit. According to another example, not shown, the flanges are double-sided, i.e. provided to be attached to the exterior 6 and the interior 5 of the cylindrical unit.

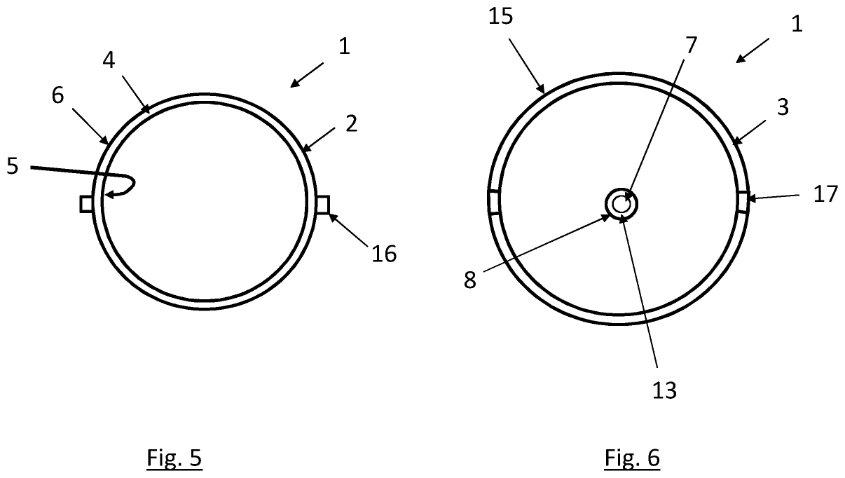

FIG. 5 schematically shows a top view of a cylindrical unit 2 of a hole saw 1 according to FIG. 4. FIG. 6 schematically shows a top view of a receiving unit 14 of a mounting device 3 for a hole saw according to FIG. 4 and a cylindrical unit 2 according to FIG. 5. FIGS. 4-6 show an example, where the receiving unit 14 comprises guides 17 in the flanges 15 with an expanse in longitudinal direction Z, provided to receive guide pins 16 provided on the cylindrical unit 2 in radial direction R. Alternatively, the receiving unit 14 can comprise guide pins 16 in radial direction and the cylindrical unit 2 corresponding guides 17 in longitudinal direction Z. The guide pins 16 and the guides 17 lock the cylindrical unit 2 in rotation direction relative to the receiving unit 14 and the mounting device 3.

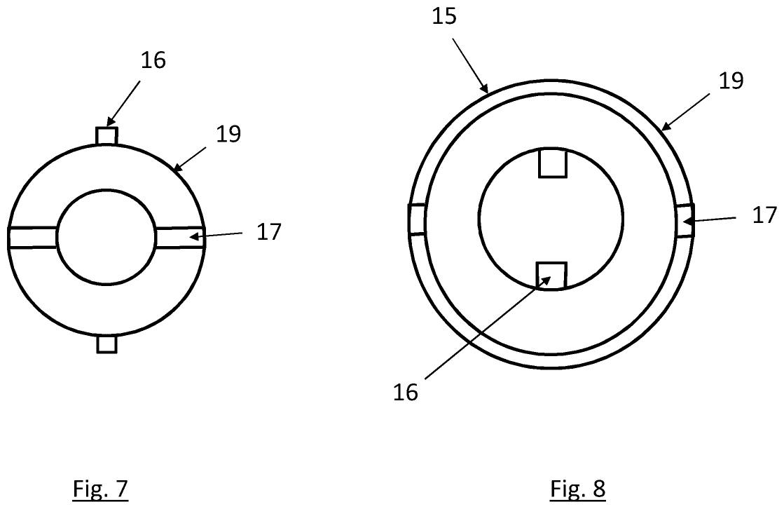

FIGS. 7 and 8 each schematically shows a top view of an example of an adapter for a cylindrical unit according to FIG. 5. The mounting device can also comprise adapters 19 that enable simple mounting of various sizes of the cylindrical unit 2. Here an adapter can comprise guides 17 with an expanse in longitudinal direction Z, provided to receive guide pins 16 provided on the cylindrical unit 2 in radial direction R. Alternatively, the adapter 19 can comprise guide pins 16 in radial direction R, and the cylindrical unit 2 corresponding guides 17 in longitudinal direction Z. FIG. 8 shows an example with an adapter comprising both guide pins 16 in radial direction R and corresponding guides 17 in longitudinal direction Z. The adapter 19 in FIG. 7 can typically be used for a smaller size of a cylindrical unit. The adapter 19 can be placed inside the receiving unit 14 and the cylindrical unit 2 inside the adapter 19. FIG. 8 shows an adapter, which can be used for a larger size of the cylindrical unit 2. The adapter 19 can here be placed on the outside of the receiving unit 14, and the cylindrical unit can be placed within or outside the flanges 15. FIG. 8 shows guide pins 16 provided in the interior of the adapter 19, and FIG. 7 shows guide pins 16 provided on the exterior of the adapter 19. The location of the guide pins 16 depends on the size of the adapter 19 and the shape of the receiving unit 14. It should also be mentioned that if the receiving unit is provided with guide pins, the adapters must correspondingly be provided with guides.

In summary, it could be mentioned that the guides and guide pins must be matched for the cylindrical unit to be attached to the receiving unit, so that it can rotate with the receiving unit. By ‘matching’ is intended that the guide pins will have to be able to slide in the guides in longitudinal direction until the cylindrical unit reaches its pre-determined position in the receiving unit.

According to one example, shown in FIG. 4, the mounting device 3 comprises a stabilization device 18, which secures the cylindrical unit 2 in place in the mounting device 3. The stabilization device 18 can be constituted by one or more rings in a flexible material, placed between the cylindrical unit 2 and the flanges 15. The rings can be placed around the cylindrical unit 2 before it is placed in the mounting device and/or can be placed inside the mounting device 3 along the flanges 15.

The guide drill 7, shown in FIGS. 1-3, can be replaced by a guide device if there is already a guide hole pre-drilled in the material. In the same way, the guide device 7 in FIGS. 4-8 can be replaced by a guide drill if there is no pre-drilled hole.

It should be mentioned that the description above constitutes an example and is not intended to limit the scope of the protection of the device. Though certain specific examples have been shown, it should be obvious to the common user within this field that certain changes can be made and that certain equivalent parts can replace those described without falling outside what is intended with the device. Modifications are possible to adapt the device for specific purposes and material. The intention is thus not to limit the device to what is shown in the figures and the examples given, but that the scope of the device instead comprises every embodiment that falls within the framework of the above description and the appended claims. Reference symbols indicated in the claims should not be viewed as limiting, as the only purpose of them is to facilitate understanding of the claims.

1. A hole saw comprising a cylindrical unit with an expanse in a longitudinal direction, the cylindrical unit being rotation-symmetrical about a center axis, which has an expanse in the longitudinal direction, the cylindrical unit being attached to a mounting device at one end and having a processing edge at the opposite end wherein the cylindrical unit is made of a homogeneous material provided to process the material to be holed by means of grinding via the processing edge, wherein the processing edge interconnects an interior and an exterior of the cylindrical unit, wherein the distance between the processing edge and the mounting device is reduced given that the material in the cylindrical unit is worn down during the processing, but wherein the processing edge has the same characteristics independently of the distance between the processing edge and the mounting device, as long as a cylindrical part of the cylindrical unit remains.

2. A hole saw according to claim 1, wherein the hole saw comprises a guide drill provided in the rotation center of the cylindrical unit, and wherein the guide drill has a length in the longitudinal direction, which exceeds the length of the cylindrical unit.

3. A hole saw according to claim 2, wherein the mounting device comprises an attachment device for the guide drill.

4. A hole saw according to claim 3, wherein the attachment device is provided to permanently attach the guide drill or wherein the attachment device is provided to removably attach the guide drill.

5. A hole saw according to claim 1, wherein the mounting device comprises a reinforcement part, which connects the cylindrical unit to the attachment device-.

6. A hole saw according to claim 1, wherein the cylindrical unit comprises folded sides, which constitute an end portion in connection with the mounting device.

7. A hole saw according to claim 1, wherein the cylindrical unit comprises an abrasive and a binder to bind the abrasive.

8. A hole saw according to claim 1, wherein the cylindrical unit comprises arming.

9. A hole saw according to claim 1, wherein the mounting device and the cylindrical unit comprise guide pins and guides provided to match for the cylindrical unit to be attached to the mounting device to be able to rotate with the mounting device.

10. A hole saw according to claim 1, wherein the mounting device comprises a stabilization device, which secures the cylindrical unit in place in the mounting device.
